(19) United States
(12) Patent Application Publication
(10) Pub. No.: US 2025/0282460 A1
(43) Pub. Date: Sep. 11, 2025

(54) SMALL WATERCRAFT AND CONTROL METHOD OF WATERCRAFT

(71) Applicant: KAWASAKI MOTORS, LTD., Akashi-shi, Hyogo (JP)

(72) Inventor: Yuka MATSUMOTO, Kobe-shi, Hyogo (JP)

(73) Assignee: KAWASAKI MOTORS, LTD., Akashi-shi, Hyogo (JP)

(21) Appl. No.: 18/599,277

(22) Filed: Mar. 8, 2024

(51) Int. Cl. B63B 79/40; B63C 9/00; B63H 21/14; B63H 21/17; B63H 21/20; B63H 21/21; G05D 1/43; G05D 1/617; G05D 1/639; G05D 109/30

(52) U.S. Cl. CPC B63B 79/40; B63C 9/0005; B63H 21/14; B63H 21/17; B63H 21/20; B63H 21/21; G05D 1/43; G05D 1/618; G05D 1/639; B63H 2021/216; G05D 2109/34

(57) ABSTRACT

A small watercraft includes: a watercraft body; a propulsion device that imparts the watercraft body with a propulsion force; a direction change device that changes a travel direction of the watercraft body; and a control unit that sets a destination of the watercraft body and executes automatic navigation control of controlling the propulsion device and the direction change device so that the watercraft body moves toward the set destination. The control unit varies control patterns of the propulsion device and the direction change device in the automatic navigation control depending on a combination of an angular difference between a destination direction that is a direction from the watercraft body toward the destination and a travel direction of the watercraft body, and a separation distance from the watercraft body to the destination.

### FIELD OF INVENTION

The present disclosure relates to a small watercraft that moves on water and a control method of a watercraft.

### BACKGROUND ART

A small watercraft described in US 2013/0102206 A1 is known as a type of small watercraft. In recent years, in order to improve the convenience of such a small watercraft (watercraft), implementation of an automatic navigation function for automatically moving the watercraft toward a destination has started to be considered. However, the efficiency of automatic navigation to a destination may deteriorate depending on route selection to the destination.

### SUMMARY OF THE INVENTION

The present disclosure has been made in view of the above circumstances, and an object thereof is to provide a technique capable of efficiently moving a small watercraft or a watercraft to a destination by automatic navigation.

In order to solve the above problem, a small watercraft according to one aspect of the present disclosure includes: a watercraft body; a propulsion device that imparts the watercraft body with a propulsion force; a direction change device that changes a travel direction of the watercraft body; and a control unit that sets a destination of the watercraft body and executes automatic navigation control of controlling the propulsion device and the direction change device so that the watercraft body moves toward the set destination, in which the control unit varies control patterns of the propulsion device and the direction change device in the automatic navigation control depending on a combination of an angular difference between a destination direction that is a direction from the watercraft body toward the destination and a travel direction of the watercraft body, and a separation distance from the watercraft body to the destination.

A method according to another aspect of the present disclosure is a control method of a watercraft including a watercraft body, a propulsion device that imparts the watercraft body with a propulsion force, and a direction change device that changes a travel direction of the watercraft body, the method including: setting a destination of the watercraft body; and executing automatic navigation control of controlling the propulsion device and the direction change device so that the watercraft body moves toward the set destination, in which in the automatic navigation control, control patterns of the propulsion device and the direction change device are varied depending on a combination of an angular difference between a destination direction that is a direction from the watercraft body toward the destination and a travel direction of the watercraft body, and a separation distance from the watercraft body to the destination.

A method according to still another aspect of the present disclosure is a control method of a watercraft including a watercraft body, a propulsion device that imparts the watercraft body with a propulsion force, and a direction change device that changes a travel direction of the watercraft body, the method including: setting a destination of the watercraft body; and executing automatic navigation control of controlling the propulsion device and the direction change device so that the watercraft body moves toward the set destination, in which the automatic navigation control is stopped when capsizing of the watercraft body is detected during the automatic navigation control.

### BRIEF DESCRIPTION OF THE DRAWINGS

FIG. 1 is a partially cutaway side view of a small watercraft according to one embodiment of the present disclosure;

FIG. 2 is a plan view of the small watercraft;

FIG. 3 is a plan cross-sectional view schematically showing a structure of an auxiliary propulsion device;

FIG. 4 is a schematic plan view showing a relationship between a drive mode of right and left thrusters in the auxiliary propulsion device and a moving direction of a watercraft body;

FIG. 5 is a block diagram showing a control system of the small watercraft;

FIG. 6 is a flowchart showing details of automatic navigation control implemented by an automatic return function;

FIG. 7 is a schematic diagram for explaining a situation in which determination in step S5 of FIG. 6 becomes YES;

FIG. 8 is a schematic diagram for explaining a definition of an angular difference between a travel direction and a destination direction;

FIG. 9 is a schematic view showing a movement route of the small watercraft to be set in a case where the angular difference is small;

FIG. 10 is a schematic diagram for explaining a situation in which determination in step S7 of FIG. 6 becomes NO;

FIG. 11 is a schematic view showing a movement route of the small watercraft to be set in a case where the angular difference is large;

FIG. 12 is a schematic diagram for explaining a situation in which determination in step S15 of FIG. 6 becomes YES;

FIG. 13 is a side view for explaining a modification of the embodiment; and

FIG. 14 is a schematic plan view for explaining another modification of the embodiment.

### DETAILED DESCRIPTION

### (1) Configuration of Small Watercraft

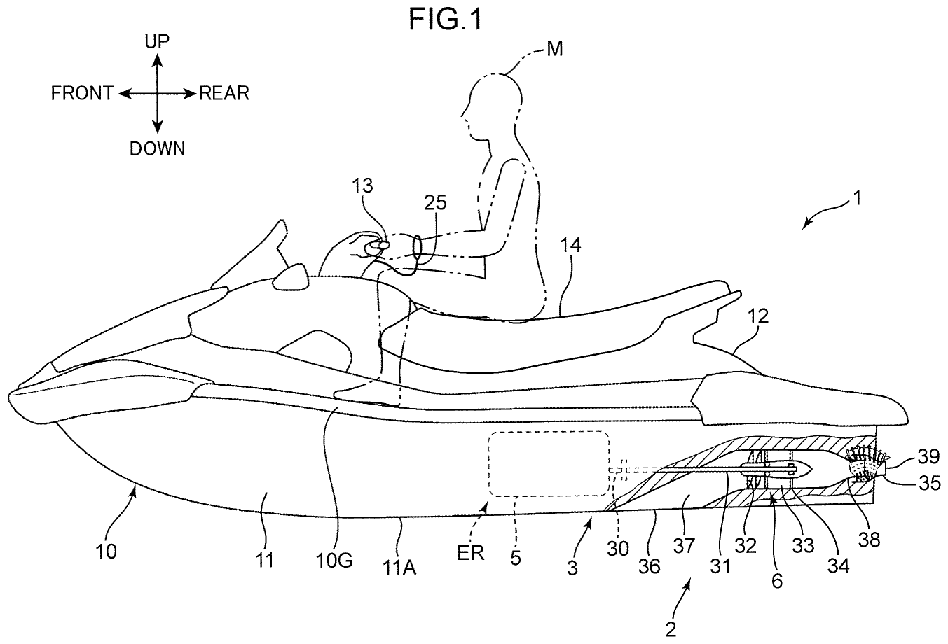

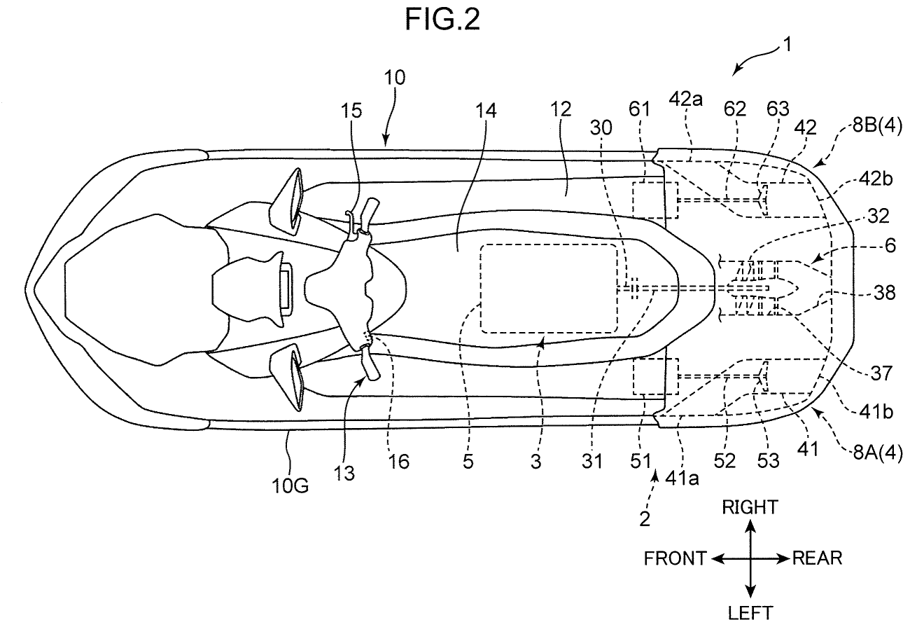

FIG. 1 is a partially cutaway side view of a small watercraft 1 according to one embodiment of the present disclosure, and FIG. 2 is a plan view of the small watercraft 1. The small watercraft 1 is a watercraft of a small size that moves on water, and is a so-called PWC in the present embodiment. That is, the small watercraft 1 is a personal watercraft of a jet propulsion type that injects a water flow rearward and moves on water in reaction to it. Hereinafter, the small watercraft 1 will be abbreviated as PWC 1.

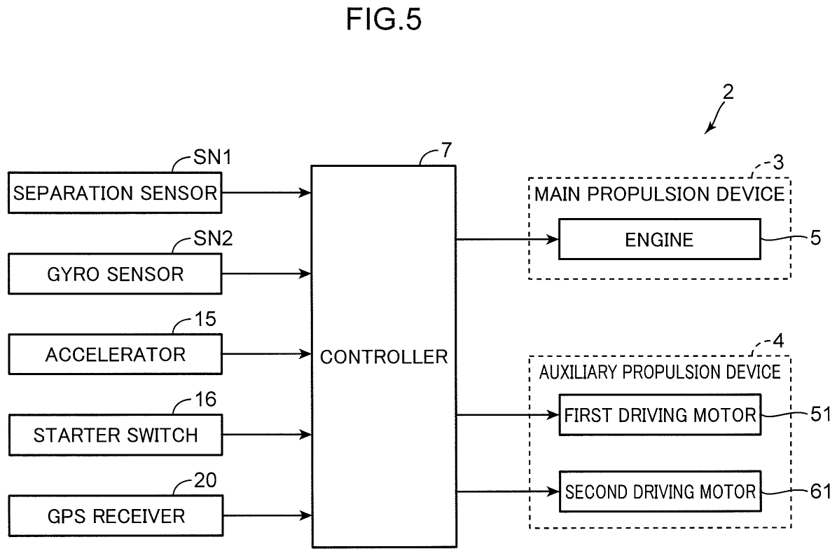

The PWC 1 includes a watercraft body 10, a propulsion device 2 that imparts the watercraft body 10 with a propulsion force, and a controller 7 (FIG. 5) that controls the propulsion device 2.

The watercraft body 10 includes a hull 11 and a deck 12 overlying the hull 11. The hull 11 and the deck 12 are connected to each other over the entire circumference by a gunwale line 10G.

A handlebar 13 and a seat 14 are disposed on the deck 12. The handlebar 13 is a steering handlebar operated by a driver M for steering of the PWC 1, and is disposed in a front upper portion of the deck 12. The seat 14 is a seat on which the driver M who operates the PWC 1 is seated.

The seat 14 is disposed at the rear of the handlebar 13 so as to cover the upper surface of the deck 12. The seat 14 may be a seat on which at least the driver M can be seated. That is, the seat 14 may be a seat for multiple persons where not only the driver M but also fellow passengers can be seated, or may be a seat for a single person where only the driver M can be seated.

The propulsion device 2 includes a main propulsion device 3 and an auxiliary propulsion device 4 (FIG. 2). The main propulsion device 3 is an engine-type propulsion device that imparts the watercraft body 10 with a propulsion force by injection of a jet water flow. The auxiliary propulsion device 4 is an electric propulsion device independent of the main propulsion device 3.

The controller 7 (FIG. 5) is a device including, as a main part, a microcomputer including a processor (CPU) that performs calculation, a memory such as a ROM or a RAM, and various input/output buses. The controller 7 adjusts output of each of the main propulsion device 3 and the auxiliary propulsion device 4 by outputting a control signal to a power source of each of the propulsion devices 3 and 4. The controller 7 corresponds to the “control unit” in the present disclosure.

The main propulsion device 3 includes an engine 5 of an internal combustion type and a jet pump 6 driven by the engine 5 to inject water.

The engine 5 is a power source that generates power for driving the jet pump 6, and includes a water-cooled four-stroke multicylinder engine using gasoline as fuel, for example. The engine 5 is accommodated in an engine room ER formed inside the hull 11. The engine 5 includes a crankshaft 30 extending in the front-rear direction as an output shaft.

The maximum output of the engine 5 or the main propulsion device 3 is set to such a value that the PWC 1 can move in a planing state by the propulsion force brought by the jet water flow from the jet pump 6. That is, the main propulsion device 3 is a relatively high output propulsion device that can move the PWC 1 in a planing state in which the watercraft body 10 is inclined in a direction in which the bow rises. The maximum output of the main propulsion device 3, in other words, the maximum propulsion force that can be generated by the main propulsion device 3 is larger than that of the auxiliary propulsion device 4 of the electric type.

The jet pump 6 is a pump that generates a jet water flow injected rearward from the watercraft body 10. Specifically, the jet pump 6 generates a jet water flow by pressurizing and accelerating water taken into watercraft body 10, and injects the generated jet water flow rearward from the watercraft body 10. The rearward injection of this jet water flow generates a propulsion force for moving the watercraft body 10 forward.

The jet pump 6 is disposed in a rear part center of the watercraft body 10. The watercraft body 10 has an impeller passage 37 at a position corresponding to the jet pump 6. The impeller passage 37 is a passage having, as an inlet, a water intake 36 formed at the width direction center of a bottom surface 11A of the hull 11, and is formed so as to penetrate the rear part of the hull 11 in the front-rear direction.

As shown mainly in FIG. 1, the jet pump 6 includes a pump shaft 31, a pump impeller 32, a stator vane 33, a pump case 34, and a jet nozzle 35.

The pump shaft 31 is coaxially coupled to the rear end of the crankshaft 30. The rear part of the pump shaft 31 is inserted into the impeller passage 37. The pump impeller 32 is attached to a rear end part of the pump shaft 31, and is thereby accommodated inside the impeller passage 37 in a state of being axially rotatable. The driving force of the engine 5 is transmitted to the pump impeller 32 via the crankshaft 30 and the pump shaft 31 and axially rotates the pump impeller 32. The pump impeller 32 rotates to generate a jet water flow. The stator vane 33 is attached at the rear of the pump impeller 32, and straightens the jet water flow generated by the pump impeller 32. The pump case 34 is disposed at the rear of the pump impeller 32 and rotatably supports the rear end part of the pump shaft 31.

The jet nozzle 35 is a nozzle having an injection port 39 for injecting a jet water flow generated by the pump impeller 32, and is disposed at the rear of the pump case 34. The jet nozzle 35 has a tapered shape in which the passage cross-sectional area decreases rearward. The jet nozzle 35 is supported by the watercraft body 10 in a state of being swingable in the right-left direction via a support shaft extending in the up-down direction.

A rear end part of the impeller passage 37 is a tapered part 38 in which the passage cross-sectional area decreases rearward. A rear part of the tapered part 38 enters the jet nozzle 35. The water taken into the impeller passage 37 from the water intake 36 is sent to the tapered part 38 and the jet nozzle 35 while being pressurized and accelerated in accordance with the rotation of the pump impeller 32, and is injected at a high speed from the outlet of the jet nozzle 35 having a narrowed passage cross-sectional area, that is, the injection port 39.

The jet nozzle 35 is linked with the handlebar 13 via a cable or the like so as to swing right and left about the support shaft in response to the steering of the handlebar 13. When the jet nozzle 35 is swung by the handlebar 13, the injection direction of the jet water flow from the injection port 39 is changed right and left, thereby changing the travel direction of the PWC 1. In other words, the handlebar 13 is a steering handlebar capable of changing the travel direction when the PWC 1 is moved using the main propulsion device 3 of the engine type. On the other hand, during movement using the auxiliary propulsion device 4 of the electric type, the travel direction can be changed without operation of the handlebar 13 (details will be described later).

As shown in FIG. 2, the handlebar 13 is provided with an accelerator 15 and a starter switch 16. The accelerator 15 is an operation lever for adjusting the moving speed of the PWC 1 by increasing or decreasing the output of the engine 5 when the PWC 1 moves using the main propulsion device 3. The starter switch 16 is a switch for starting and stopping the engine 5.

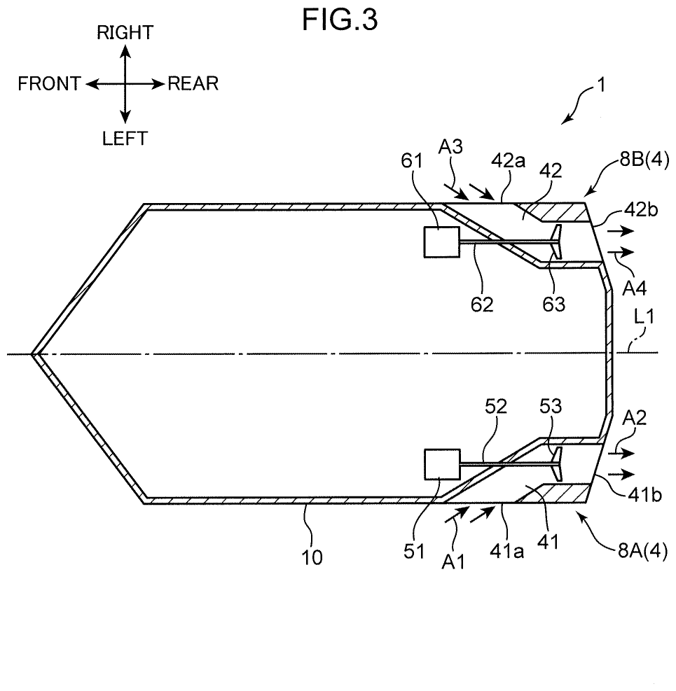

FIG. 3 is a plan cross-sectional view schematically showing the structure of the auxiliary propulsion device 4. As shown mainly in FIGS. 2 and 3, the auxiliary propulsion device 4 includes a pair of right and left thrusters 8A and 8B of an electric type provided at the rear part of the watercraft body 10. The maximum output of the auxiliary propulsion device 4 (thrusters 8A and 8B) is set lower than that of the main propulsion device 3 of the engine type including the jet pump 6. Vibration and noise generated when the auxiliary propulsion device 4 is driven at the maximum output are smaller than vibration and noise generated when the main propulsion device 3 is driven at the maximum output.

The thruster 8A is disposed on the left side of the jet pump 6, that is, on the left rear part of the watercraft body 10. The thruster 8B is disposed on the right side of the jet pump 6, that is, on the right rear part of the watercraft body 10. That is, the pair of thrusters 8A and 8B are disposed on both right and left side parts of the rear part of the watercraft body 10 so as to be aligned right and left across a center axis L1 (FIG. 3) of the watercraft body 10 extending in the front-rear direction. Hereinafter, the thruster 8A on the left side is appropriately called the left thruster 8A, and the thruster 8B on the right side is called the right thruster 8B.

The left thruster 8A includes a first driving motor 51 of an electric type, a propeller shaft 52 extending rearward from the first driving motor 51, and an impeller 53 attached to a rear end of the propeller shaft 52.

The watercraft body 10 has a left water passage 41 at a position corresponding to the left thruster 8A. The left water passage 41 is a passage penetrating the left rear part of the hull 11 in the front-rear direction, and has a front opening 41a opening to the left side surface of the rear part of the hull 11 and a rear opening 41b opening to the rear surface of the hull 11 as shown in FIG. 3. The front opening 41a opens diagonally forward left, that is, forward and leftward, and the rear opening 41b opens substantially straight rearward. The rear opening 41b is opened in parallel with a corresponding opening (a rear opening 42b described later) of the right thruster 8B.

The rear part of the propeller shaft 52 is inserted into the left water passage 41. The impeller 53 attached to the rear end of the propeller shaft 52 is accommodated inside the left water passage 41 in a state of being axially rotatable. The driving force of the first driving motor 51 is transmitted to the impeller 53 via the propeller shaft 52 and rotates the impeller 53. Rotation of the impeller 53 generates a rearward water flow. That is, by the rotation of the impeller 53, water is sucked into the left water passage 41 from the front opening 41a of the left water passage 41 (see arrow A1), and the sucked water is injected rearward from the rear opening 41b (see arrow A2). This rearward injection imparts the left side part of the watercraft body 10 with a forward propulsion force.

The right thruster 8B has a similar structure to that of the left thruster 8A. That is, the right thruster 8B includes a second driving motor 61 of an electric type, a propeller shaft 62 extending rearward from the second driving motor 61, and an impeller 63 attached to a rear end of the propeller shaft 62.

The watercraft body 10 has a right water passage 42 at a position corresponding to the right thruster 8B. The right water passage 42 is a passage penetrating the right rear part of the hull 11 in the front-rear direction, and has a shape symmetrical to the left water passage 41 described above. That is, the right water passage 42 has a front opening 42a opening to the right side surface of the rear part of the hull 11 and a rear opening 42b opening to the rear surface of the hull 11. The front opening 42a opens diagonally forward right, and the rear opening 42b opens substantially straight rearward.

The rear part of the propeller shaft 62 is inserted into the right water passage 42. The impeller 63 attached to the rear end of the propeller shaft 62 is accommodated inside the right water passage 42 in a state of being axially rotatable. The driving force of the second driving motor 61 is transmitted to the impeller 63 via the propeller shaft 62 and rotates the impeller 63. Rotation of the impeller 63 generates a rearward water flow. That is, by the rotation of the impeller 63, water is sucked into the right water passage 42 from the front opening 42a of the right water passage 42 (see arrow A3), and the sucked water is injected rearward from the rear opening 42b (see arrow A4). This rearward injection imparts the right side part of the watercraft body 10 with a forward propulsion force.

Here, since the left thruster 8A and the right thruster 8B are disposed symmetrically across the center axis L1 of the watercraft body 10, when only one of the thrusters 8A and 8B is driven, a turning force acts on the watercraft body 10. For example, when only the left thruster 8A is driven and water is injected rearward from the rear opening 41b, a forward propulsion force is generated in the left side part of the watercraft body 10, and as a result, a turning force for rotating the watercraft body 10 clockwise acts on the watercraft body 10. Similarly, when only the right thruster 8B is driven and water is injected rearward from the rear opening 42b, a forward propulsion force is generated in the right side part of the watercraft body 10, and as a result, a turning force for rotating the watercraft body 10 anticlockwise acts on the watercraft body 10. On the other hand, when the right and left thrusters 8A and 8B are both driven at the same output, the turning forces by the thrusters 8A and 8B cancel each other out, and as a result, a turning force substantially no longer acts on the watercraft body 10 and only a forward propulsion force acts on the watercraft body 10.

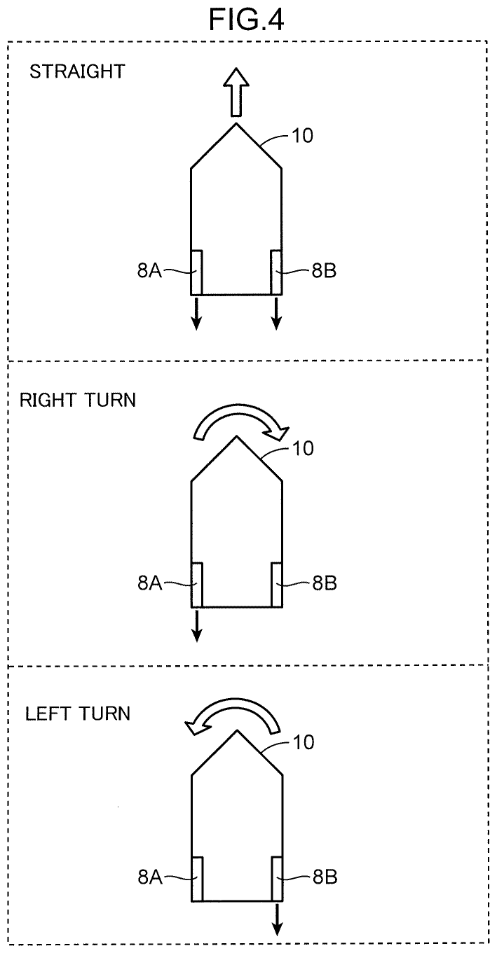

As described above, through output adjustment of the right and left thrusters 8A and 8B, the auxiliary propulsion device 4 can impart the watercraft body 10 with a forward propulsion force and impart the watercraft body 10 with a turning force. That is, as shown in the upper part of FIG. 4, the auxiliary propulsion device 4 can move the watercraft body 10 straight forward by driving the right and left thrusters 8A and 8B at the same output. As shown in the middle part of FIG. 4, the auxiliary propulsion device 4 can turn the watercraft body 10 clockwise by driving the left thruster 8A and stopping the right thruster 8B, and can turn the watercraft body 10 anticlockwise by driving the right thruster 8B and stopping the left thruster 8A as shown in the lower part of FIG. 4. Furthermore, the auxiliary propulsion device 4 can also move forward while changing the travel direction to either left or right by driving both the right and left thrusters 8A and 8B and providing them with an output difference. In this manner, the auxiliary propulsion device 4 in the present embodiment has both a function as a “propulsion device” that imparts the watercraft body 10 with a propulsion force and a function as a “direction change device” that changes the travel direction of the watercraft body 10.

As shown in FIG. 1, in the PWC 1 of the present embodiment, a tether 25 made of a flexible cord that connects the driver M and the watercraft body 10 to each other is prepared. That is, one end part of the tether 25 is removably connected to the watercraft body 10, and the other end part of the tether 25 is connected to the driver M. In the present embodiment, one end part of the tether 25 is connected to a vicinity of the handlebar 13 in the watercraft body 10 in a normal time where the driver M is on the seat 14. The other end part of the tether 25 is connected to the wrist of the driver M in the example of FIG. 1. However, the other end part of the tether 25 may be connected to an appropriate position of the driver M, and the connection destination is not limited to the wrist.

The tether 25 is used to detect falling of the driver M into water. That is, when the driver M falls into water from the watercraft body 10, one end part of the tether 25 comes out of the watercraft body 10 along with an increase in the distance between the driver M and the watercraft body 10. In other words, the falling of the driver M into water can be recognized by coming off of the tether 25.

The watercraft body 10 is attached with a separation sensor SN1 (FIG. 5) that detects that one end part of the tether 25 has come out of the watercraft body 10. A type of the separation sensor SN1 is not limited as long as it can detect coming off of the tether 25, and for example, an engine stop switch for forcibly stopping the engine 5 can also be used as the separation sensor SN1. In this case, one end part of the tether 25 is removably connected to the engine stop switch in such an aspect that the switch is maintained in an off state. When the driver M falls into water and one end part of the tether 25 comes out of the engine stop switch, the switch is switched from the off state to an on state, thereby stopping the engine 5. That is, in a case where the tether 25 is connected to the engine stop switch, a signal indicating switching of the switch from the off state to the on state can be used as a signal indicating falling of the driver M into water. Note that the separation sensor SN1 corresponds to the “falling overboard detection unit” in the present disclosure.

FIG. 5 is a block diagram showing the control system of the PWC 1. As shown in FIG. 5, the watercraft body 10 is attached with a gyro sensor SN2 in addition to the separation sensor SN1 described above. The gyro sensor SN2 is a sensor that detects an angular velocity around three axes orthogonal to one another. The output from the gyro sensor SN2 is used to specify the orientation of the watercraft body 10, for example.

The watercraft body 10 is attached with a GPS receiver 20. The GPS receiver 20 can receive a signal transmitted from a GPS satellite, and specify the position on the earth of the PWC 1 (watercraft body 10) based on the received signal.

The controller 7 is electrically connected to the separation sensor SN1, the gyro sensor SN2, the accelerator 15, the starter switch 16, and the GPS receiver 20 described above. The controller 7 receives detection signals or operation signals output from these elements.

The controller 7 is electrically connected to the engine 5, which is a power source of the main propulsion device 3, and is electrically connected to the first driving motor 51 and the second driving motor 61, which are power sources of the auxiliary propulsion device 4 (thrusters 8A and 8B). By controlling elements such as a fuel injection valve and an ignition plug included in the engine 5, for example, the controller 7 adjusts the output of the engine 5, in other words, the propulsion force of the main propulsion device 3. The controller 7 controls the output of each of the first driving motor 51 and the second driving motor 61, thereby adjusting the propulsion forces of the left thruster 8A and the right thruster 8B, respectively.

### (2) Automatic Navigation Control

The PWC 1 has an automatic navigation function of automatically moving toward a preset destination. The destination may be a destination set by a passenger such as the driver M, for example, through an interface of a navigation device or the like, or may be a destination automatically set by the controller 7 under a certain condition. In the present embodiment, as an example of the latter, the PWC 1 includes a so-called automatic return function of performing automatic navigation with a falling overboard point where the driver M has fallen into water as a destination. Hereinafter, the automatic navigation control implemented by this automatic return function will be described in detail.

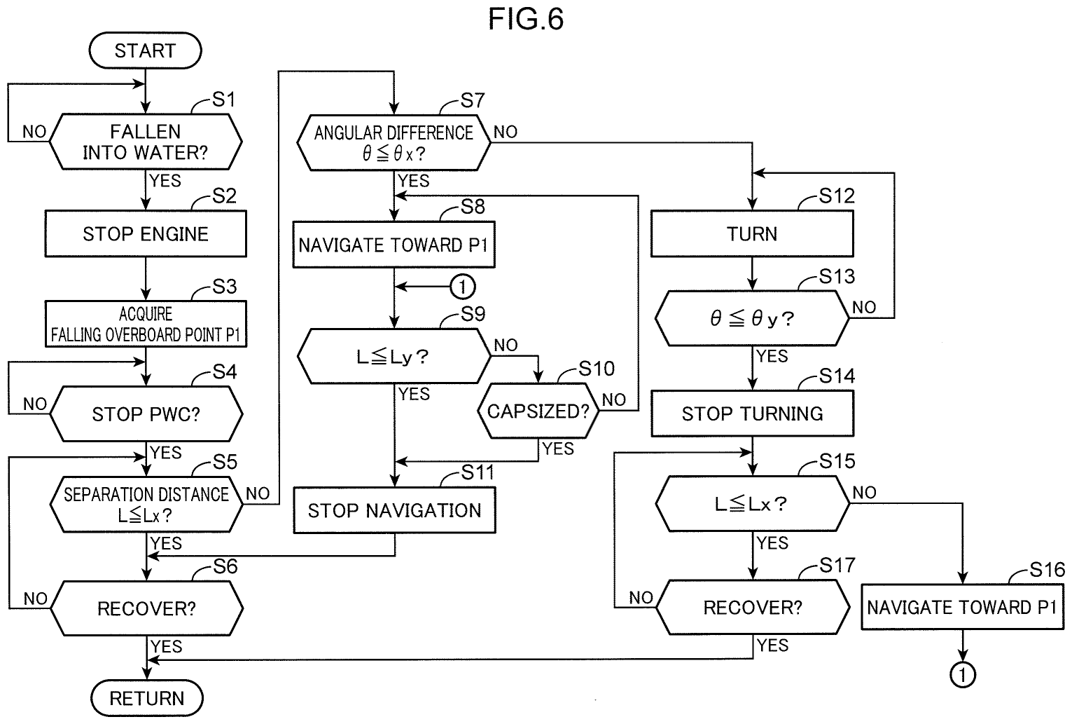

FIG. 6 is a flowchart showing details of the automatic navigation control by the automatic return function described above. On the premise that control in FIG. 6 is started, it is assumed that the PWC 1 is navigating by the main propulsion device 3. That is, the control in FIG. 6 is started in a state where the engine 5, which is the power source of the main propulsion device 3, is driven and the first and second driving motors 51 and 61, which are the power source of the auxiliary propulsion device 4, are stopped.

When the control of FIG. 6 is started, the controller 7 determines whether or not the driver M has fallen into water based on a signal from the separation sensor SN1 (step S1). That is, when a signal indicating that one end part of the tether 25 has come out of the watercraft body 10 is input from the separation sensor SN1, the controller 7 determines that the driver M has separated.

If determining YES in step S1 and confirming falling of the driver M into water, the controller 7 stops the engine 5 (step S2).

Together with step S2 described above, the controller 7 acquires a falling overboard point P1 where the driver M has fallen into water (step S3). That is, the controller 7 acquires, from the GPS receiver 20, the position of the PWC 1 at the time point when confirming the falling into water in step S1, and stores the position as the falling overboard point P1. The combination of the controller 7 and the GPS receiver 20 corresponds to the “falling overboard point detection unit” in the present disclosure.

Next, the controller 7 determines whether or not the PWC 1 has stopped (step S4). That is, the controller 7 determines that the PWC 1 has stopped at the time point when the watercraft speed, which is the moving speed of the PWC 1 (watercraft body 10), decreases to a sufficiently low value at which the PWC 1 can be regarded to have stopped. In the present embodiment, the watercraft speed can be calculated based on a change in position information input from the GPS receiver 20. In this case, the GPS receiver 20 corresponds to the “watercraft speed detection unit” in the present disclosure. In place of this, a watercraft speed sensor different from the GPS receiver 20 may be provided, and the watercraft speed sensor may directly detect the watercraft speed.

If determining YES in step S4 described above and confirming stop of the PWC 1, the controller 7 calculates a separation distance L, which is a distance from the current position of the PWC 1 (watercraft body 10) specified from the information of the GPS receiver 20 to the falling overboard point Pl acquired in step S3 described above, and determines whether or not the calculated separation distance L is equal to or less than a predetermined reference distance Lx (step S5). That is, also after the engine 5 stops along with the falling of the driver M into water, the PWC 1 moves by inertia and stops at a place away from the falling overboard point P1. The separation distance L determined in step S5 means a distance by which the PWC 1 has moved away from the falling overboard point P1 by such an inert movement. The reference distance Lx can be set as appropriate, and can be set to, for example, about 5 to 10 m.

If determining YES in step S5 and confirming that the separation distance L is equal to or less than the reference distance Lx, the controller 7 determines whether or not the driver M has recovered to the PWC 1 (step S6). The recovery of the driver M can be determined based on a signal from the separation sensor SN1. That is, the controller 7 determines that the driver M has recovered to the PWC 1 when the separation sensor SN1 detects that one end part of the tether 25 is connected to the watercraft body 10 again.

If determining YES in step S6 and confirming the recovery of the driver M, the controller 7 ends (returns) the series of processing.

On the other hand, if determining NO in step S6 and confirming that the driver M has not recovered to the PWC 1, the controller 7 returns to step S5 and repeats determination of the separation distance L. If the determination here is YES, the process transitions again to the recovery determination (S6) of the driver M. In other words, as long as the determination in step S5 continues to be YES, that is, as long as the PWC 1 remains in a range where the separation distance L is equal to or less than the reference distance Lx, the controller 7 performs neither the navigation operation (S8) nor the turning operation (S12) described later.

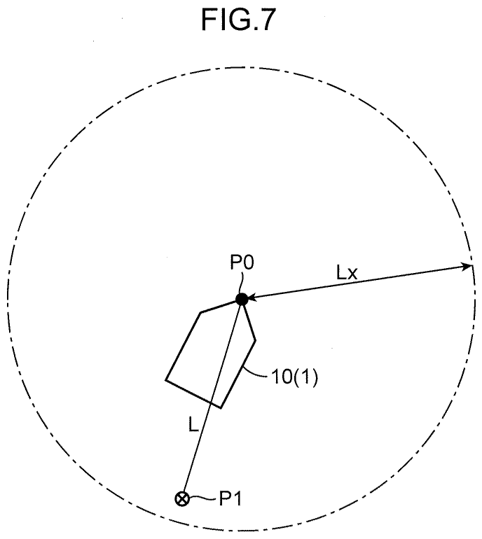

FIG. 7 is a schematic diagram for explaining a situation in which determination in step S5 becomes YES. As shown in FIG. 7, the separation distance L from the PWC 1 to the falling overboard point P1 is calculated as a distance from a reference point P0 of the watercraft body 10 to the falling overboard point P1. The reference point P0 of the watercraft body 10 may be any position of the watercraft body 10 and is not limited to a specific position, and in the present embodiment, the tip end part of the watercraft body 10, that is, the bow is set as the reference point P0. The fact that the determination in step S5 is YES means that the falling overboard point P1 is included in a circle having a radius Lx about the reference point P0, in other words, that the PWC1 is present near the falling overboard point P1. In this manner, when the PWC 1 is present near the falling overboard point P1, it is less necessary to move the PWC 1 toward the falling overboard point P1, and therefore, the automatic navigation control is not performed.

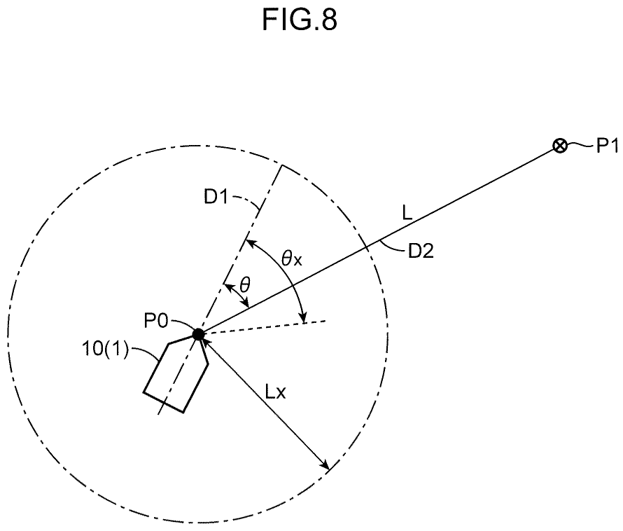

On the other hand, if determining NO in step S5 and confirming that the separation distance L exceeds the reference distance Lx, the controller 7 calculates an angular difference θ shown in FIG. 8 and determines whether or not the calculated angular difference θ is equal to or less than a predetermined reference angle θx (step S7). As shown in FIG. 8, the angular difference θ is an angle formed by a destination direction D2, which is a direction from the PWC 1 (watercraft body 10) toward the falling overboard point P1, and a travel direction D1 of the PWC 1 (watercraft body 10). The controller 7 calculates the destination direction D2 based on the current position of the PWC 1 specified from the information of the GPS receiver 20 and the information of the falling overboard point Pl acquired in step S3, and calculates the angular difference θ between the both directions D1 and D2 based on the calculated destination direction D2 and the travel direction D1 of the PWC 1 at the present time point specified from the detection value of the gyro sensor SN2. The reference angle θx can be set as appropriate, and can be set to, for example, about 40 to 60°.

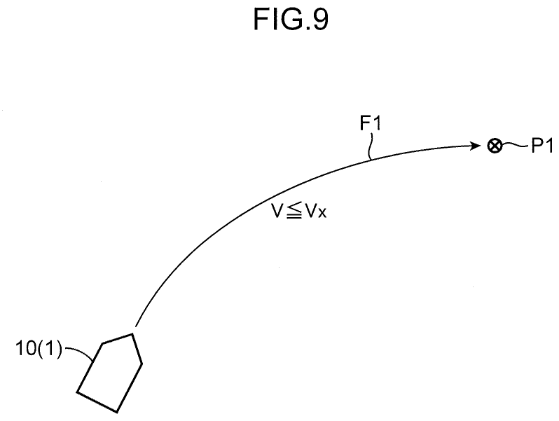

FIG. 8 shows a situation in which the determination in step S7 becomes YES. As shown in FIG. 8, the fact that the determination is YES in step S7 means that the angular difference θ between the travel direction D1 and the destination direction D2 is equal to or less than the reference angle θx, and the separation distance L from the PWC1 to the falling overboard point P1 exceeds the reference distance Lx. In this case, as indicated by the arrow F1 in FIG. 9, the controller 7 performs a navigation operation of moving the PWC 1 toward the falling overboard point P1 (step S8). In this navigation operation, the controller 7 calculates the separation distance L and the angular difference θ each time based on the position information input from the GPS receiver 20 and the gyro sensor SN2, that is, the information indicating the orientation and the position of the PWC 1. Furthermore, the controller 7 performs feedback control on the right and left thrusters 8A and 8B of the auxiliary propulsion device 4 so that the PWC 1 moves in a direction in which the separation distance L and the angular difference θ calculated each time each decreases. Due to this, the PWC 1 gradually approaches the falling overboard point P1 as the destination.

Here, in a case where the angular difference θ at the time point of starting the navigation operation in step S8 is not zero, the PWC 1 needs to move while changing the direction. In this case, the controller 7 achieves the direction change by making a difference in output of the both thrusters 8A and 8B while driving each of the right and left thrusters 8A and 8B. That is, the controller 7 does not perform the operation of turning the PWC 1 by driving only one of the thrusters 8A and 8B but adjusts the travel direction of the PWC 1 while driving the both thrusters 8A and 8B, thereby causing the PWC 1 to approach the falling overboard point P1.

During the navigation operation in step S8, as shown in FIG. 9, the controller 7 suppresses the moving speed of the PWC 1, that is, a watercraft speed V, to be equal to or less than a predetermined upper limit speed Vx. That is, the controller 7 calculates the watercraft speed V each time from the information of the GPS receiver 20, and adjusts the outputs of the right and left thrusters 8A and 8B so that the calculated watercraft speed V becomes equal to or less than the upper limit speed Vx. The upper limit speed Vx is set to a value sufficiently lower than the maximum speed set at the normal time before the automatic navigation control is performed, that is, at the normal navigation control in which the main propulsion device 3 moves the PWC 1 non-automatically. The upper limit speed Vx can be set as appropriate, and can be, for example, about 10 km/m. In other words, during the automatic navigation control, the controller 7 suppresses the watercraft speed V to be equal to or less than the upper limit speed Vx by suppressing the output of the auxiliary propulsion device 4 (thrusters 8A and 8B) to be equal to or less than an output lower than the maximum output of the main propulsion device 3.

After the navigation operation (S8) as described above is started, the controller 7 determines whether or not the separation distance L has decreased to equal to or less than a predetermined distance Ly along with the navigation operation (step S9). The predetermined distance Ly is set to a value equal to or less than the reference distance Lx described above. That is, the predetermined distance Ly may be the identical value to the reference distance Lx (e.g., 5 to 10 m) or may be a value smaller than the reference distance Lx.

If determining NO in step S9 and confirming that the separation distance L has not decreased to the predetermined distance Ly, the controller 7 determines whether or not the PWC 1 (watercraft body 10) has capsized (step S10). This determination can be made based on input information from the gyro sensor SN2. In this case, the gyro sensor SN2 corresponds to the “capsizing detection unit” in the present disclosure.

If determining NO in step S10 and confirming that the PWC 1 has not capsized, the controller 7 returns to step S8 described above and continues the navigation operation.

On the other hand, if determining YES in step S10 and confirming the capsizing of the PWC 1 or if determining YES in step S9 and confirming that the separation distance L has decreased to equal to or less than the predetermined distance Ly, the controller 7 stops the navigation operation (step S11). That is, the controller 7 stops the navigation of the PWC 1 by stopping both the right and left thrusters 8A and 8B. Thereafter, the controller 7 performs recovery determination (S6) of the driver M.

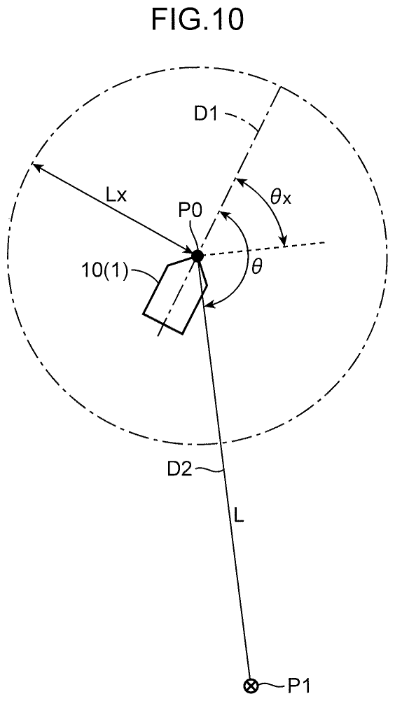

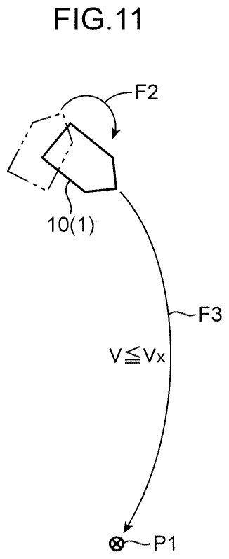

Next, the control in a case of determining NO in step S7 will be described. FIG. 10 shows a situation in which the determination in step S7 becomes NO. As shown in FIG. 10, the fact that determination of NO in step S7 means that the angular difference θ between the travel direction D1 and the destination direction D2 exceeds the reference angle θx, and the separation distance L from the PWC1 to the falling overboard point P1 exceeds the reference distance Lx. In this case, as indicated by the arrow F2 in FIG. 11, the controller 7 performs a turning operation of turning the PWC 1 in a direction in which the angular difference θ decreases (step S12). In this turning operation, the controller 7 calculates the angular difference θ each time based on the position information input from the GPS receiver 20 and the gyro sensor SN2, that is, the information indicating the orientation and the position of the PWC 1. Furthermore, the controller 7 performs feedback control on the right and left thrusters 8A and 8B of the auxiliary propulsion device 4 so that the PWC 1 turns in a direction in which the angular difference θ calculated each time decreases. At this time, as shown in FIG. 4, the controller 7 drives only the left thruster 8A when turning the PWC 1 rightward, and drives only the right thruster 8B when turning the PWC 1 leftward.

Next, the controller 7 determines whether or not the angular difference θ has decreased to equal to or less than a predetermined angle θy along with the turning operation (step S13). The predetermined angle θy is set to a value equal to or less than the reference angle θx described above. That is, the predetermined angle θy may be the identical value to the reference angle θx (e.g., 40 to 60°) or may be a value smaller than the reference angle θx.

If determining NO in step S13 and confirming that the angular difference θ has not decreased to the predetermined angle θy, the controller 7 continues the turning operation (S12).

On the other hand, if determining YES in step S13 and confirming that the angular difference θ has decreased to equal to or less than the predetermined angle θy, the controller 7 stops the turning operation (step S14). That is, the controller 7 stops the turning of the PWC 1 by stopping both the right and left thrusters 8A and 8B.

Next, the controller 7 calculates, based on the input information from the GPS receiver 20 and the like, the separation distance L from the PWC 1 to the falling overboard point P1 at the time point when the turning is stopped, and determines whether or not the calculated separation distance L is equal to or less than the reference distance Lx (step S15).

If determining NO in step S15 and confirming that the separation distance L exceeds the reference distance Lx, the controller 7 performs a navigation operation of moving the PWC 1 toward the falling overboard point P1 as indicated by the arrow F3 in FIG. 11 (step S16). That is, the controller 7 adjusts the outputs of the right and left thrusters 8A and 8B while driving each of the right and left thrusters 8A and 8B, thereby moving the PWC 1 in a direction in which the separation distance L and the angular difference θ each decrease, in other words, in a direction in which the PWC 1 approaches the falling overboard point P1. At this time, the controller 7 adjusts the outputs of the right and left thrusters 8A and 8B such that the watercraft speed V becomes equal to or less than the upper limit speed Vx, similarly to the case of step S8 described above.

After the start of the navigation operation in step S16, the controller 7 transitions to step S9, determines the separation distance L, and continues the navigation operation until the separation distance L reaches the predetermined distance Ly.

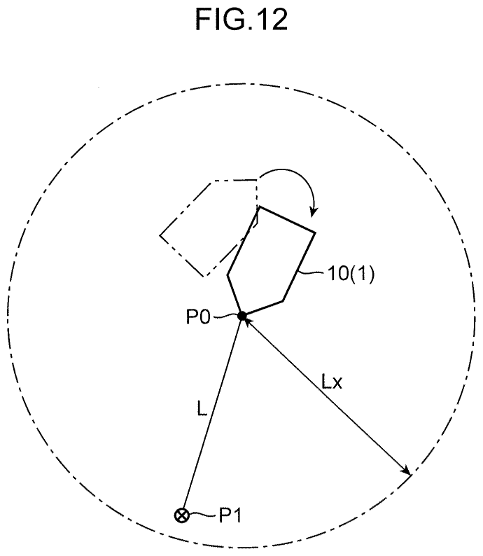

On the other hand, if determining YES in step S15 and confirming that the separation distance L is equal to or less than the reference distance Lx, the controller 7 determines whether or not the driver M has recovered to the PWC 1 (step S17). Here, the fact that the determination in step S15 is YES means that as shown in FIG. 12, the separation distance L from the PWC 1 (reference point P0) to the falling overboard point P1 is reduced accidentally as a result of the turning operation (S12) of the PWC 1, whereby the separation distance L becomes equal to or less than the reference distance Lx. In this case, since the PWC 1 is present near the falling overboard point P1, it is not necessary to perform the navigation operation. Therefore, the controller 7 ends (returns) the series of processing through the recovery determination of the driver M (S17).

### (3) Actions and Effects

As described above, in the present embodiment, at the time of the automatic navigation control of automatically moving the PWC 1 to the falling overboard point P1 of the driver M, the control pattern of the auxiliary propulsion device 4, which is a power source for movement and direction change of the PWC 1, can be varied depending on the combination of the separation distance L and the angular difference θ acquired before the start of the automatic navigation control. For example, when the separation distance L from the PWC 1 to the falling overboard point P1 exceeds the reference distance Lx and the angular difference θ between the travel direction D1 and the destination direction D2 of the PWC 1 exceeds the reference angle θx, that is, when the determination in step S7 is NO, the turning operation (S12) of turning the PWC 1 in the direction in which the angular difference θ decreases and the navigation operation (S16) of moving the PWC 1 in the direction in which the PWC 1 approaches the falling overboard point P1 are performed in this order. On the other hand, when the separation distance L exceeds the reference distance Lx but the angular difference θ is equal to or less than the reference angle θx, that is, when the determination in step S7 is YES, the navigation operation (S8) is immediately performed and the turning operation is not performed. According to such a configuration, there is an advantage that the PWC 1 can be efficiently moved to the falling overboard point P1 (destination) by automatic navigation.

That is, in the present embodiment, when the separation distance L exceeds the reference distance Lx and the angular difference θ exceeds the reference angle θx, that is, when both the separation distance L and the angular difference θ are large, the turning operation (S12) of directing the travel direction D1 of the PWC 1 toward the falling overboard point P1 is performed first, and thereafter the navigation operation (S16) of moving the PWC 1 toward the falling overboard point P1 is performed. Due to this, since the distance of the automatic navigation route followed by the PWC 1 is shortened, it is possible to shorten the time required for the PWC 1 to reach the vicinity of the falling overboard point P1. For example, when the navigation operation is performed suddenly in a situation where both the separation distance L and the angular difference θ are large, the PWC1 moves in a direction away from the falling overboard point P1 at least in an initial stage of the navigation operation, which is considered to cause an increase in the distance of the automatic navigation route, in other words, an increase in the time required to reach the falling overboard point P1. On the other hand, according to the present embodiment in which the navigation operation is performed after the turning operation, it is possible to suppress the PWC 1 from moving in a direction away from the falling overboard point P1. Due to this, it is possible to shorten the time required to reach the falling overboard point P1 and to achieve an efficient movement to the falling overboard point P1.

On the other hand, when the separation distance L exceeds the reference distance Lx and the angular difference θ is equal to or less than the reference angle θx, that is, when the separation distance L is large but the angular difference θ is small, the navigation operation (S8) is immediately started without through the turning operation, and therefore the PWC1 can be moved to the falling overboard point P1 in a short time.

In the present embodiment, during the navigation operation, the angular difference θ and the separation distance L are calculated each time based on the position information (position and orientation) of the PWC 1 input from the gyro sensor SN2 and the GPS receiver 20, and the right and left thrusters 8A and 8B of the auxiliary propulsion device 4 are controlled so that the PWC 1 moves in a direction in which the calculated angular difference θ and the calculated separation distance L are reduced. According to such a configuration, the PWC 1 can be appropriately moved toward the falling overboard point P1 by the navigation operation.

Specifically, during the navigation operation, both the right and left thrusters 8A and 8B are driven, and the travel direction D1 of the PWC 1 is controlled by adjusting the outputs of the both thrusters. According to such a configuration, it is possible to appropriately move the PWC 1 toward the falling overboard point P1 by the propulsion force generated by the both thrusters 8A and 8B.

On the other hand, during the turning operation, the angular difference θ is calculated each time based on the position information of the PWC 1, and the right and left thrusters 8A and 8B are controlled so that the PWC 1 turns in a direction in which the calculated angular difference θ decreases. According to such a configuration, the travel direction D1 of the PWC 1 can be appropriately directed toward the falling overboard point P1 by the turning operation.

Specifically, during the turning operation, one of the right and left thrusters 8A and 8B is driven and the other is stopped, whereby the PWC 1 is turned anticlockwise or clockwise. According to such a configuration, the PWC 1 can be appropriately turned by selectively using driving/stopping of each of the thrusters 8A and 8B, and the auxiliary propulsion device 4 (thrusters 8A and 8B) can also be used as a direction change device.

In the present embodiment, after start of the navigation operation (S8 or S16), the navigation operation is stopped at the time point when the separation distance L becomes equal to or less than the predetermined distance Ly (S11). According to such a configuration, the navigation operation can be appropriately continued until the PWC 1 approaches the falling overboard point P1.

In the present embodiment, when the separation distance L acquired after the turning operation (S12) exceeds the reference distance Lx, the process transitions to the navigation operation (S16), and on the other hand, when the separation distance L is equal to or less than the reference distance Lx, the process does not transition to the navigation operation, and the automatic navigation control is stopped. According to such a configuration, when the PWC1 accidentally approaches the vicinity of the falling overboard point P1 as a result of the turning operation, it is possible to prevent an unnecessary navigation operation from being performed thereafter.

In the present embodiment, when the separation distance L, which is the distance from the PWC 1 stopped after falling of the driver M into water to the falling overboard point P1, is equal to or less than the reference distance Lx, that is, when the determination in step S5 is YES, neither the turning operation nor the navigation operation is performed. According to such a configuration, it is possible to prevent automatic navigation control from being unnecessarily performed in a situation where the PWC 1 is close to the falling overboard point P1.

In the present embodiment, during the navigation operation (S8 or S16), the watercraft speed V, which is the moving speed of the PWC 1, is suppressed to become equal to or less than the upper limit speed Vx. According to such a configuration, it is possible to suppress damage to the PWC 1 when the PWC 1 collides with an obstacle during the navigation operation.

In the present embodiment, when capsizing of the PWC 1 (S10) is detected in the middle of the navigation operation, the navigation operation is stopped. According to such a configuration, it is possible to prevent the PWC 1 from being navigated in a capsizing state.

In the present embodiment, during the automatic navigation control, the main propulsion device 3 including the engine 5 is stopped, and the auxiliary propulsion device 4 (thrusters 8A and 8B) of the electric type having a maximum output lower than that of the main propulsion device 3 is driven. According to such a configuration, it is possible to perform automatic navigation control at an appropriate watercraft speed using the auxiliary propulsion device 4 of the electric type with a low output in which fine adjustment of the output is easy, and it is possible to gently move the PWC 1 to the vicinity of the driver M who has fallen into water.

### (4) Modification

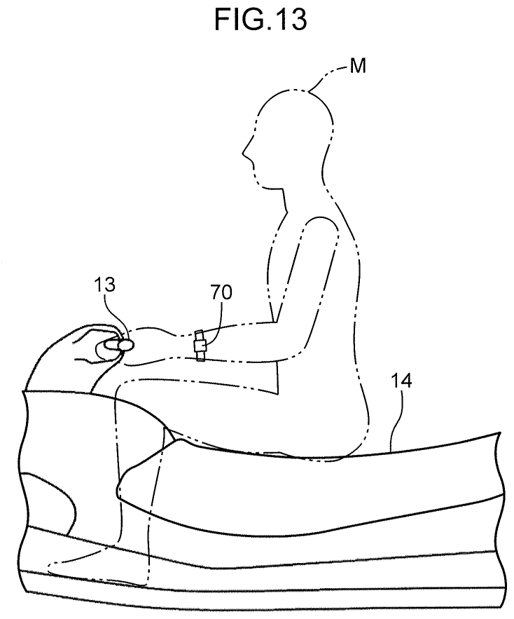

In the above embodiment, when the coming off of the tether 25 connecting the driver M and the watercraft body 10 to each other is detected by the separation sensor SN1, it is determined that the driver M has fallen into water from the watercraft body 10, but the method of determining the falling of the driver M into water is not limited to this. For example, as shown in FIG. 13, falling of the driver M into water may be determined by using a wearable terminal 70 carried by the driver M. The wearable terminal 70 is a terminal capable of communicating with a communication unit provided on the watercraft body 10. The wearable terminal 70 includes a GPS receiver for specifying a position on the earth. In this case, the falling of the driver M into water can be determined based on the position information of the watercraft body 10 acquired from the GPS receiver 20 on the watercraft body 10 side and the position information of the wearable terminal 70 (driver M) input from the wearable terminal 70 to the communication unit. That is, when the distance from the watercraft body 10 to the driver M calculated from the position information of the both exceeds a predetermined value, it can be determined that the driver M has fallen into water. In this manner, the wearable terminal 70 in the example of FIG. 13 functions as the “falling overboard detection unit” that detects falling of the driver M into water. Note that in FIG. 13, a watch-type terminal wound around the wrist of the driver M is shown as the wearable terminal 70, but the wearable terminal may be a terminal carried by the driver M, and may take other appropriate forms.

Furthermore, the wearable terminal 70 described above can also be used as a means for detecting the position of the driver M after falling into water. That is, the wearable terminal 70 functions as the “driver position detection unit” that detects the position of the driver M after falling into water. In this case, since the position of the driver M after falling into water is detected in real time by the wearable terminal 70, the convenience of the PWC 1 can be further enhanced by performing the automatic navigation control described above with the detected position of the driver M as the destination. That is, according to the present aspect in which the wearable terminal 70 is worn on the driver M, even if the driver M moves on water after falling into water, the position after the movement can be acquired each time from the wearable terminal 70. Therefore, the PWC 1 can be moved by the automatic navigation control to the vicinity of the position of the driver M after the movement, and the convenience of the PWC 1 can be enhanced.

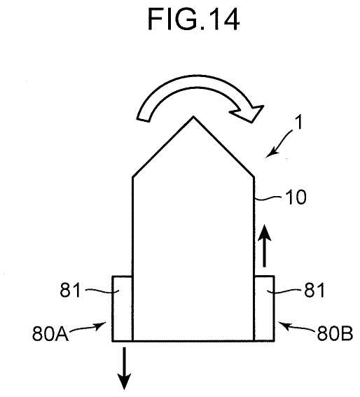

In the above embodiment, both of the pair of thrusters 8A and 8B constituting the auxiliary propulsion device 4 are provided inside the watercraft body 10, but as in the PWC 1 shown in FIG. 14, a pair of thrusters 80A and 80B may be attached outside the watercraft body 10. Each of the thrusters 80A and 80B includes an electric motor as a power source and an impeller rotationally driven by the electric motor, similarly to the thrusters 8A and 8B of the above embodiment, for example. The electric motor and the impeller are built in a casing 81 attached to the right and left outer side surfaces of the watercraft body 10. The casing 81 may be removable from the watercraft body 10.

In the above embodiment, the thrusters 8A and 8B capable of injecting a water flow only to the rear are used, but a thruster capable of selectively injecting a water flow to either the front or the rear may be used. When such a thruster is used, the PWC 1 can be not only moved forward but also moved backward. As shown in FIG. 14, the PWC 1 can be turned by injecting water flows in opposite directions from the right and left thrusters 80A and 80B. For example, in the example of right turn shown in FIG. 14, a water flow is injected rearward from the left thruster 80A, and a water flow is injected forward from the right thruster 80B. Due to this, the left side part of the watercraft body 10 is imparted with a forward propulsion force, and the right side part of the watercraft body 10 is imparted with a rearward propulsion force, and as a result, the PWC 1 turns rightward. In this manner, when the right and left thrusters 80A and 80B are driven in opposite directions to each other at the time of turning, the turning performance of the PWC 1 can be enhanced. The change of the injection direction of the water flow from the thruster can be implemented by changing the rotation direction of the impeller using a motor (drive source) capable of forward rotation and reverse rotation, for example. Alternatively, the injection direction of the water flow may be changed by selectively rotationally driving a first impeller that generates a rearward water flow and a second impeller that generates a forward water flow using an identical motor.

In addition to a thruster (longitude thruster) that injects a water flow in the front-rear direction as in the thrusters 8A and 8B (80A and 80B) described above, a lateral thruster that injects a water flow in the left-right direction may be attached to the watercraft body 10. In this case, it is possible to use the propulsion force by the water flow injected leftward or rightward from the lateral thruster as at least a part of the propulsion force for turning the PWC 1.

In the above embodiment, the navigation operation is stopped when the PWC 1 capsizes in the middle of the navigation operation (S8 or S16) for causing the PWC 1 to approach the destination (falling overboard point), but the condition (stop condition) for stopping the navigation operation is not limited to capsizing of the PWC 1. For example, it may be determined that the stop condition is satisfied when any of the following situations is confirmed, an obstacle is detected ahead in the travel direction of the PWC 1, an abnormality is confirmed in any of the sensors (the GPS receiver 20 and the gyro sensor SN2) for acquiring the position information (position and orientation) of the PWC 1, and an operation signal for stopping the PWC 1 is transmitted from a remote controller carried by the user to remotely operate the PWC 1.

In the above embodiment, an example in which the present disclosure is applied to a personal watercraft (PWC), which is an example of a small watercraft, has been described, but a small watercraft (or watercraft) to which the present disclosure can be applied is not limited to a PWC as long as it is a watercraft that can move on water. For example, the present disclosure may be applied to a propeller propulsion watercraft that obtains a propulsion force by rotation of a propeller.

### Summary

The above-described embodiment and its modification include the following disclosure.

A small watercraft according to one aspect of the present disclosure includes: a watercraft body; a propulsion device that imparts the watercraft body with a propulsion force; a direction change device that changes a travel direction of the watercraft body; and a control unit that sets a destination of the watercraft body and executes automatic navigation control of controlling the propulsion device and the direction change device so that the watercraft body moves toward the set destination. The control unit varies control patterns of the propulsion device and the direction change device in the automatic navigation control depending on a combination of an angular difference between a destination direction that is a direction from the watercraft body toward the destination and a travel direction of the watercraft body, and a separation distance from the watercraft body to the destination.

According to this aspect, since the control pattern of automatic navigation control can be varied depending on a combination of the angular difference between the travel direction and the destination direction, and the separation distance to the destination, the watercraft body can be moved toward the destination along an appropriate route in accordance with the angular difference and the separation distance.

Preferably, the control unit acquires the angular difference and the separation distance before start of the automatic navigation control, and when the acquired angular difference exceeds a reference angle and the acquired separation distance exceeds a reference distance, as the automatic navigation control, performs, in this order, a turning operation of turning the watercraft body in a direction in which the angular difference decreases and a navigation operation of moving the watercraft body in a direction of approaching the destination.

In this aspect, when both the angular difference between the travel direction and the destination direction, and the separation distance to the destination are large, the turning operation of directing the travel direction of the watercraft body toward the destination is performed first, and thereafter the navigation operation of moving the watercraft body toward the destination is performed. Due to this, since the distance of the automatic navigation route followed by the watercraft body is shortened, it is possible to shorten the time required to reach the destination.

Preferably, the control unit stops the automatic navigation control at a time point when the separation distance becomes equal to or less than a predetermined distance after start of the automatic navigation control.

In this aspect, the automatic navigation control can be appropriately continued until the watercraft body approaches the destination.

Preferably, in the small watercraft, the control unit acquires the separation distance after the turning operation, transitions to the navigation operation if the acquired separation distance exceeds the reference distance, and stops the automatic navigation control without transitioning to the navigation operation if the acquired separation distance is equal to or less than the reference distance.

In this aspect, when the watercraft body accidentally approaches the vicinity of the destination as a result of the turning operation, it is possible to prevent an unnecessary navigation operation from being performed thereafter.

Preferably, the control unit performs neither the turning operation nor the navigation operation when the separation distance before start of the automatic navigation control is equal to or less than the reference distance.

In this aspect, it is possible to prevent automatic navigation control from being unnecessarily performed in a situation where the watercraft body is close to the destination.

Preferably, the control unit performs the navigation operation without the turning operation when the separation distance exceeds the reference distance and the angular difference is equal to or less than the reference angle before start of the automatic navigation control.

In this aspect, when the angular difference between the travel direction and the destination direction is small, the navigation operation is immediately started, and thus the watercraft can move to the destination in a short time.

Preferably, during the turning operation, the control unit calculates the angular difference based on position information of the watercraft body, and controls the direction change device so that the watercraft body turns in a direction in which the calculated angular difference decreases.

In this aspect, the travel direction of the watercraft body can be appropriately directed to the destination by the turning operation.

Preferably, during the navigation operation, the control unit calculates the angular difference and the separation distance based on position information of the watercraft body, and controls the propulsion device and the direction change device so that the watercraft body moves in a direction in which the calculated angular difference and the calculated separation distance decrease, respectively.

In this aspect, the watercraft body can be appropriately moved toward the destination by the navigation operation.

Preferably, the control unit stops the automatic navigation control when a predetermined stop condition is satisfied during the automatic navigation control.

In this aspect, the automatic navigation control can be stopped when necessary.

Preferably, the small watercraft further includes a capsizing detection unit that detects capsizing of the watercraft body. The control unit determines that the stop condition is satisfied when the capsizing detection unit detects the capsizing.

In this aspect, navigation in a capsizing state can be prevented.

Preferably, the small watercraft further includes a watercraft speed detection unit that detects a watercraft speed, which is a moving speed of the watercraft body. During the navigation operation, the control unit controls the propulsion device so that a watercraft speed detected by the watercraft speed detection unit becomes equal to or less than an upper limit speed lower than a maximum speed set before the automatic navigation control.

In this aspect, it is possible to suppress damage to the watercraft when the watercraft collides with an obstacle during the navigation operation.

Preferably, the propulsion device includes an electric propulsion device with an electric motor as a power source. The control unit performs the navigation operation using the electric propulsion device.

In this aspect, since the navigation operation is performed using the electric propulsion device in which fine adjustment of the output is easy, the watercraft speed at the time of the navigation operation can be appropriately suppressed to equal to or less than the upper limit speed.

Preferably, the propulsion device includes a main propulsion device driven during normal navigation control in which a watercraft body is moved non-automatically, and an auxiliary propulsion device driven during the automatic navigation control. The control unit suppresses an output of the auxiliary propulsion device to be equal to or less than an output lower than a maximum output of the main propulsion device during the automatic navigation control.

In this aspect, the automatic navigation control can be performed at an appropriate watercraft speed using the auxiliary propulsion device of low output.

Preferably, the propulsion device includes a main propulsion device driven during normal navigation control in which a watercraft body is moved non-automatically, and an auxiliary propulsion device independent of the main propulsion device. The control unit stops the main propulsion device and drives the auxiliary propulsion device during the automatic navigation control.

In this aspect, the automatic navigation control can be performed at an appropriate watercraft speed using the auxiliary propulsion device.

Preferably, the small watercraft further includes: a falling overboard detection unit that detects falling of a driver into water; and a falling overboard point detection unit that detects a falling overboard point, which is a point where the falling into water has occurred. The control unit executes the automatic navigation control when the falling overboard detection unit detects the falling into water, and sets the falling overboard point detected by the falling overboard point detection unit as a destination of the automatic navigation control.

In this aspect, the watercraft body can be automatically moved to the vicinity of the driver who has fallen into water, and recover of the driver to the watercraft body can be facilitated.

Preferably, the propulsion device includes a main propulsion device using an internal combustion engine as a power source and an auxiliary propulsion device using an electric motor as a power source. When the falling overboard detection unit detects the falling into water, the control unit stops the main propulsion device and then performs the automatic navigation control using the auxiliary propulsion device.

In this aspect, during the automatic navigation control toward the falling overboard point, the main propulsion device of an engine type is stopped and the auxiliary propulsion device of an electric type is driven, and thus the watercraft body can be gently moved to the vicinity of the driver who has fallen into water.

Preferably, the small watercraft further includes: a falling overboard detection unit that detects falling of a driver into water; and a driver position detection unit that detects a position of the driver after falling into water. The control unit executes the automatic navigation control when the falling overboard detection unit detects the falling into water, and sets a position of the driver detected by the driver position detection unit as a destination of the automatic navigation control.

In this aspect, the watercraft body can be moved toward the position of the driver detected in real time after falling into water.

A method according to another aspect of the present disclosure is a control method of a watercraft including a watercraft body, a propulsion device that imparts the watercraft body with a propulsion force, and a direction change device that changes a travel direction of the watercraft body, the method including: setting a destination of the watercraft body; and executing automatic navigation control of controlling the propulsion device and the direction change device so that the watercraft body moves toward the set destination. In the automatic navigation control, control patterns of the propulsion device and the direction change device are varied depending on a combination of an angular difference between a destination direction that is a direction from the watercraft body toward the destination and a travel direction of the watercraft body, and a separation distance from the watercraft body to the destination.

According to this aspect, the watercraft body can be moved toward the destination along an appropriate route in accordance with the angular difference and the separation distance.

A method according to still another aspect of the present disclosure is a control method of a watercraft including a watercraft body, a propulsion device that imparts the watercraft body with a propulsion force, and a direction change device that changes a travel direction of the watercraft body, the method including: setting a destination of the watercraft body; and executing automatic navigation control of controlling the propulsion device and the direction change device so that the watercraft body moves toward the set destination. The automatic navigation control is stopped when capsizing of the watercraft body is detected during the automatic navigation control.

According to this aspect, it is possible to prevent the watercraft from being navigated in a capsizing state.

1. A small watercraft comprising:
a watercraft body;
a propulsion device that imparts the watercraft body with a propulsion force;
a direction change device that changes a travel direction of the watercraft body; and
a control unit that sets a destination of the watercraft body and executes automatic navigation control of controlling the propulsion device and the direction change device so that the watercraft body moves toward the set destination,
wherein the control unit varies control patterns of the propulsion device and the direction change device in the automatic navigation control depending on a combination of an angular difference between a destination direction that is a direction from the watercraft body toward the destination and a travel direction of the watercraft body, and a separation distance from the watercraft body to the destination.

2. The small watercraft according to claim 1, wherein the control unit acquires the angular difference and the separation distance before start of the automatic navigation control, and when the acquired angular difference exceeds a reference angle and the acquired separation distance exceeds a reference distance, as the automatic navigation control, performs, in this order, a turning operation of turning the watercraft body in a direction in which the angular difference decreases and a navigation operation of moving the watercraft body in a direction of approaching the destination.

3. The small watercraft according to claim 2, wherein the control unit stops the automatic navigation control at a time point when the separation distance becomes equal to or less than a predetermined distance after start of the automatic navigation control.

4. The small watercraft according to claim 2, wherein the control unit acquires the separation distance after the turning operation, transitions to the navigation operation if the acquired separation distance exceeds the reference distance, and stops the automatic navigation control without transitioning to the navigation operation if the acquired separation distance is equal to or less than the reference distance.

5. The small watercraft according to claim 2, wherein the control unit performs neither the turning operation nor the navigation operation when the separation distance before start of the automatic navigation control is equal to or less than the reference distance.

6. The small watercraft according to claim 2, wherein the control unit performs the navigation operation without the turning operation when the separation distance exceeds the reference distance and the angular difference is equal to or less than the reference angle before start of the automatic navigation control.

7. The small watercraft according to claim 2, wherein during the turning operation, the control unit calculates the angular difference based on position information of the watercraft body, and controls the direction change device so that the watercraft body turns in a direction in which the calculated angular difference decreases.

8. The small watercraft according to claim 2, wherein during the navigation operation, the control unit calculates the angular difference and the separation distance based on position information of the watercraft body, and controls the propulsion device and the direction change device so that the watercraft body moves in a direction in which the calculated angular difference and the calculated separation distance decrease, respectively.

9. The small watercraft according to claim 1, wherein the control unit stops the automatic navigation control when a predetermined stop condition is satisfied during the automatic navigation control.

10. The small watercraft according to claim 9, further comprising a capsizing detection unit that detects capsizing of the watercraft body,
wherein the control unit determines that the stop condition is satisfied when the capsizing detection unit detects the capsizing.

11. The small watercraft according to claim 2, further comprising a watercraft speed detection unit that detects a watercraft speed, which is a moving speed of the watercraft body,
wherein during the navigation operation, the control unit controls the propulsion device so that a watercraft speed detected by the watercraft speed detection unit becomes equal to or less than an upper limit speed lower than a maximum speed set before the automatic navigation control.

12. The small watercraft according to claim 11, wherein
the propulsion device includes an electric propulsion device with an electric motor as a power source, and
the control unit performs the navigation operation using the electric propulsion device.

13. The small watercraft according to claim 1, wherein
the propulsion device includes a main propulsion device driven during normal navigation control in which a watercraft body is moved non-automatically, and an auxiliary propulsion device driven during the automatic navigation control, and
the control unit suppresses an output of the auxiliary propulsion device to be equal to or less than an output lower than a maximum output of the main propulsion device during the automatic navigation control.

14. The small watercraft according to claim 1, wherein
the propulsion device includes a main propulsion device driven during normal navigation control in which a watercraft body is moved non-automatically, and an auxiliary propulsion device independent of the main propulsion device, and
the control unit stops the main propulsion device and drives the auxiliary propulsion device during the automatic navigation control.

15. The small watercraft according to claim 1, further comprising:
a falling overboard detection unit that detects falling of a driver into water; and
a falling overboard point detection unit that detects a falling overboard point, which is a point where the falling into water has occurred,
wherein the control unit executes the automatic navigation control when the falling overboard detection unit detects the falling into water, and sets the falling overboard point detected by the falling overboard point detection unit as a destination of the automatic navigation control.

16. The small watercraft according to claim 15, wherein
the propulsion device includes a main propulsion device using an internal combustion engine as a power source and an auxiliary propulsion device using an electric motor as a power source, and
when the falling overboard detection unit detects the falling into water, the control unit stops the main propulsion device and then performs the automatic navigation control using the auxiliary propulsion device.

17. The small watercraft according to claim 1, further comprising:
a falling overboard detection unit that detects falling of a driver into water; and
a driver position detection unit that detects a position of the driver after falling into water,
wherein the control unit executes the automatic navigation control when the falling overboard detection unit detects the falling into water, and sets a position of the driver detected by the driver position detection unit as a destination of the automatic navigation control.

18. A control method of a watercraft including a watercraft body, a propulsion device that imparts the watercraft body with a propulsion force, and a direction change device that changes a travel direction of the watercraft body, the method comprising:
setting a destination of the watercraft body; and
executing automatic navigation control of controlling the propulsion device and the direction change device so that the watercraft body moves toward the set destination,
wherein in the automatic navigation control, control patterns of the propulsion device and the direction change device are varied depending on a combination of an angular difference between a destination direction that is a direction from the watercraft body toward the destination and a travel direction of the watercraft body, and a separation distance from the watercraft body to the destination.

19. A control method of a watercraft including a watercraft body, a propulsion device that imparts the watercraft body with a propulsion force, and a direction change device that changes a travel direction of the watercraft body, the method comprising:
setting a destination of the watercraft body; and
executing automatic navigation control of controlling the propulsion device and the direction change device so that the watercraft body moves toward the set destination,
wherein the automatic navigation control is stopped when capsizing of the watercraft body is detected during the automatic navigation control.
